(19) United States
(12) Patent Application Publication
(10) Pub. No.: US 2010/0311011 A1
(43) Pub. Date: Dec. 9, 2010

(54) ABUTMENT WITH INLAY FOR DENTAL IMPLANTS

(75) Inventors: Fabian Schwieder, Basel (CH); Daniel Guenter, Waldenburg (CH)

Correspondence Address: SCULLY SCOTT MURPHY & PRESSER, PC, 400 GARDEN CITY PLAZA, SUITE 300, GARDEN CITY, NY, 11530, US

(73) Assignee: STRAUMANN HOLDING AG, Basel (CH)

(21) Appl. No.: 12/867,534

(22) PCT Filed: Feb. 11, 2009
(86) PCT No.: PCT/EP2009/051574

§ 371 Date: Aug. 13, 2010

(30) Foreign Application Priority Data
Feb. 13, 2008 (EP) 08151358.2

(51) Int. Cl. A61C 13/225

(52) U.S. Cl. 433/172

(57) ABSTRACT

The invention relates to an abutment with inlay for dental implants, comprising an outer abutment part and an inlay, which is disposed apically within the outer abutment part. The inlay has a coronal section, which is suitable for producing a connection between the inlay and the outer abutment part, and an apical region, which is suitable for the detachable connection with a dental implant. The invention wherein the surface of the coronal section of the inlay is constructed in order to positively connect the outer abutment part, which is to be mounted undetachably thereon.

### FIELD OF USE OF THE INVENTION

The present invention generally refers to an abutment with inlay, for establishing a connection between a dental implant and an abutment, particularly for screw- or cylinder-shaped dental implants, wherein the abutment having an inlay proves for anti-rotational securing and allows an easy assembly of the fabricated individual denture.

### PRIOR ART

An abutment is generally fastened on a dental implant, which is sufficiently known in the art and which is inserted in the jaw bone of a patient, the abutment being either a permanent or a temporary element. To achieve good fixation and reinforcement of the abutment, an intermediate element called inlay is inserted in the abutment in the direction of the dental implant. The abutment can be inserted both temporarily, e. g. during the healing process of a dental implant, or permanently, at the end of treatment, for providing a denture modeled on the abutment.

The inlay generally consists of a high-strength metal or a metal alloy for better absorption of the forces which occur during tightening of a connection screw which connects the abutment to the inlay of the dental implant. Materials which are particularly suitable for an inlay are gold, titanium or alloys thereof which, on the one hand, have high mechanical stability and rigidity and, on the other hand, very good biocompatibility. The connection assembly consisting of abutment and inlay fixed therein is inserted, during treatment, in a cylindrical opening in the coronal section of a dental implant or in an exterior support on the dental implant, respectively.

For reproducible positioning of the abutment, advantageously allowing e. g. easy replacement of a temporary abutment by an abutment with a crown, and for anti-rotational securing, a non-rotationally symmetrical receiving contour can be provided in the location hole of the dental implant or in the exterior support on the dental implant, respectively, which can be engaged by a corresponding non-rotationally symmetrical complementary outer contour located apically on the abutment. The abutment is fixed into place in a female thread axially provided inside the dental implant, by screwing of a connection screw through a first opening in the abutment and a second opening in the inlay. When the connection screw has been tightened, a conical shaft portion of the screw positively engages a complementary apical inner cone of the inlay. The shaft portion of the screw which has no thread is substantially completely enclosed within the inlay, and the apical screw portion having a male thread engages a corresponding female thread of a dental implant. Thus, the connection screw provides a fixation of the abutment to a dental implant in an axial direction. The interlocking, non-rotationally symmetrical structures of a one-piece abutment or an abutment with inlay ensure an anti-rotational securing about a virtual central axis, i. e. the abutment with inlay cannot rotate with respect to a dental implant. Additionally, the inlay is stably connected to the abutment so that it can be neither rotated nor displaced.

From EP 1 656 904 A1, such a dental implant system having an abutment with an inserted inlay is known. The inlay has an apical portion with a profile formed on the surface, which profile is suitable for permanent connection between an abutment and a dental implant. The inlay has at least one shoulder portion around which an exterior abutment portion is formed. This forming can take place e. g. by means a modeling method also called “molding”. The disadvantage of a modeling method, however, is that each molded model is unique, and if errors occur e. g. during manufacturing, the shape must be reworked at high cost or a new abutment must be produced. The shoulder portions protrude from the abutment's surface, and the relatively small area of the supporting surface in this region for an abutment formed thereon entails the danger of loosening of the material bond between the inlay material and the abutment material, either due to material fatigue or due to the forces exerted during chewing. When such loosening takes place, the abutment can rotate about its own axis, necessitating its replacement. For ensuring the best possible strength and long-term stability of the abutment with inlay, the connection between inner abutment surface and outer inlay surface must be nearly monolithic.

A well-known method for achieving good adhesion between the metal materials consists in enlarging the surfaces of the materials to be connected to each other. The shoulder portions of the inlay mentioned above allow this enlargement to a small extent as compared to a circular symmetric design.

During the formation process, however, clearances can be formed between the shoulder portions, e. g. if the forming material, due the surface tension thereof, cannot completely reach the inlay surface. This can lead to the trapping of air between the inner abutment surface and the outer inlay surface, causing a reduction in overall stability due to the inhomogeneous distribution of the formed parts.

The materials used for forming differ depending on their area of application. For instance, plastics or metal are used for temporary abutments, which are inexpensive and do not have to meet any particular aesthetic requirements. If dentures, such as crowns, are used, precious metals and their alloys are employed as well as special ceramics or modern composites.

The shoulder portions are arranged substantially rotationally symmetrically on the surface of the inlay. For fixation of the dental implant with the abutment, a screw is screwed into the dental implant through an opening in the abutment, the conical screw head being pressed into a complementary inner portion of the inlay. This connection achieves stability and stiffening of the dental implant system; however, there is no anti-rotational securing in the apical portion where the abutment is formed to the inlay. In case of application of a force which deviates from the central axis, this can lead to a rotational movement of the abutment on the inlay.

A displacement of teeth, even on a minor scale, must be prevented in dental technology, both for aesthetic and for health reasons. The displacement of an abutment can cause gaps where food particles can accumulate and lead to caries and paradontosis. Therefore, a displaced abutment must be replaced as soon as possible. On the other hand, a replacement leads to additional costs for manufacturing and placement of the new abutment, and disadvantageously, the patient must be subjected to a new treatment.

Another problem is that in the area where the apical, inclined shoulder portion of the inlay is located, which forms the transition between the inlay and the upper edge of the dental implant, the cross-section of the abutment material formed to the inlay is very thin; therefore, the abutment material may chip off in case of pressure applied, e. g. due to the chewing of hard foods. Inlays are relatively expensive to produce since in case of metal cutting, e. g. by milling, several operative steps are needed to form the relatively delicate shoulder portions, or in case of master forming, very expensive prototypes have to be manufactured.

### SUMMARY OF THE INVENTION

It is therefore an object of the present invention to find a solution which offers better adhesion of an inlay to the interior of an abutment.

In addition, it is a particular object of the present invention to find a solution which offers anti-rotational securing for a formed abutment.

Within this aim, another object of the present invention is to provide an abutment with inlay which is inexpensive to manufacture and to assemble.

This and other objects to be found in the following specification are solved by an abutment with inlay for dental implants according to claim 1. Other advantageous embodiments of the invention are set out in the dependent claims.

### SHORT DESCRIPTION OF THE FIGURES

Other characteristics and advantages of the present invention as well as the method of operation of the exemplary embodiment of the present invention are described below with reference to the accompanying drawings.

The accompanying drawings exemplify the present invention and are furthermore used, together with the specification, to explain the basics of the invention and to enable a person skilled in the art to manufacture and use the invention.

The following applies throughout the entire further specification: if reference numbers are contained in a figure for clarity purposes, but not explained in the specification text that directly corresponds to it, they are referred to in preceding figure descriptions.

For the purposes of clarity, there is generally no repeated designation of components in successive figures if they can be clearly recognized as “repetitive” components.

In detail, the figures show the following:

FIG. 1 shows a sectional view of an abutment with inlay in assembled form, according to one embodiment of the invention;

FIG. 2A shows a side view of an inlay according to one embodiment of the invention;

FIG. 2B shows a top view of the inlay of FIG. 2A;

FIG. 2C shows a bottom view of the inlay of FIG. 2A;

FIG. 2D shows a perspective view of the inlay of FIG. 2A and

FIG. 3 shows a sectional view of an abutment with inlay in assembled form according to another embodiment of the invention.

### DESCRIPTION OF PREFERRED EMBODIMENTS OF THE INVENTION

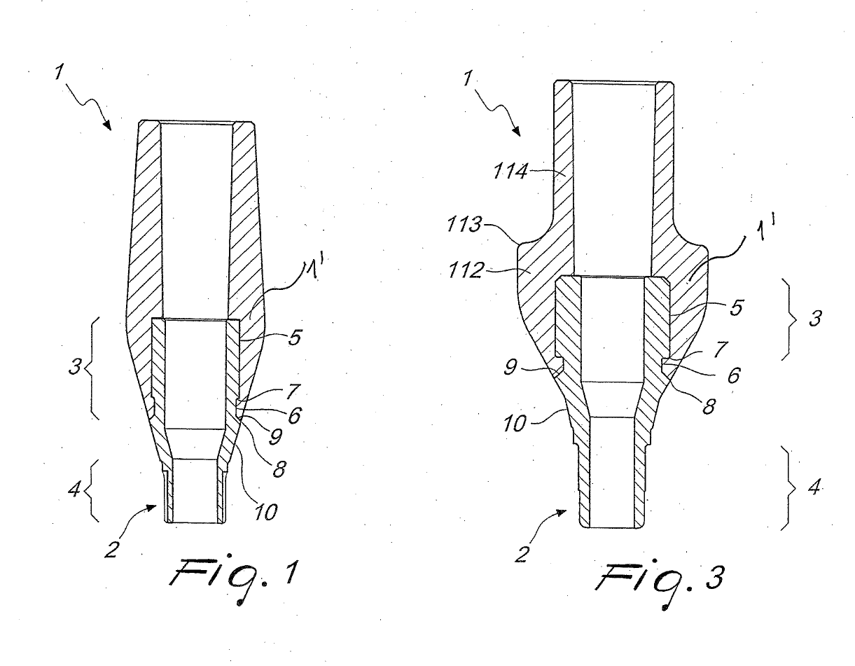

With reference to FIG. 1, a currently preferred embodiment of an abutment with inlay according to the present invention is described, which abutment is generally designated by reference number 1. An abutment with inlay for provision of a dental implant, which as such is sufficiently known and therefore not described further, comprises an exterior abutment portion 1′ within which an inlay 2 is arranged apically.

The inlay 2 coronally has an outer portion 3 which is suitable to provide a connection between the inlay 2 and the outer abutment portion 1′ and an apical portion 4 which is suitable for releasable connection to a dental implant.

The surface 5 of the coronal portion 3 of the inlay 2 is shaped such that an outer abutment part 1′ can positively engage it and be connected to it practically in a non-detachable manner. In positive engagement, an outer abutment part 1′ manufactured previously is simply pressed onto the coronal portion 3 of the inlay 2. Alternatively, the outer abutment portion 1′ can be injected onto the inlay 2. Since no modeling or casting process is necessary in this case, a plurality of variants of abutments can be produced very inexpensively. This is of importance especially in the case of temporary abutments 1 since they have no high aesthetic requirements to meet. Complicated apparatuses for manufacturing, such as forming presses, are not necessary. A simple press is sufficient for positioning the outer abutment part 1′.

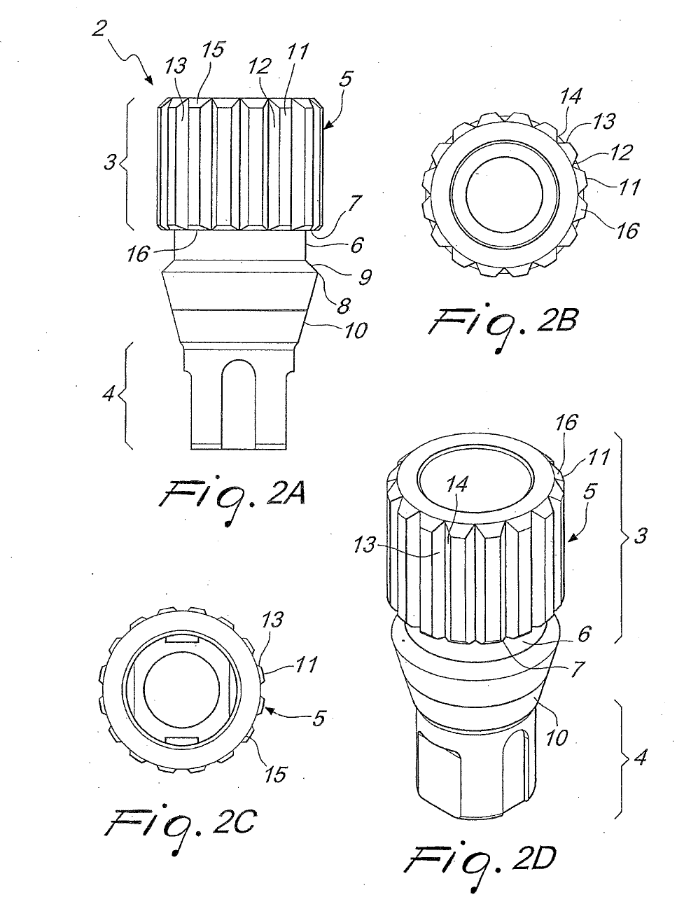

At least part, or even the entire surface 5, of the coronal portion 3 of the inlay 2 has a profile described in detail in FIGS. 2A-D with which the outer abutment part 1′ is in contact. In connected form, the abutment part 1′ is substantially monolithic with the inlay 2. The coronal portion 3 borders on a rotationally symmetrical cylindrical portion 6 enclosed by a first edge 7 and a second edge 8. A conical shoulder portion 9 is formed between the rotationally symmetrical cylindrical portion 6 and the second edge 8. A conical portion 10, decreasing in diameter, extends from the second edge 8 in the direction of the apical portion 4 which is used to be inserted in a complementary cone portion of the dental implant not shown.

FIGS. 2A through 2D show other features of the inlay 2 for illustration in different views. In this embodiment, the coronal portion 3 consists of a plurality of crests 11 and recesses 12 arranged between them. The coronal surface 5 of the coronal portion 3 of the inlay 2 can be produced by cutting, e.g. milling, or non-cutting, such as stamping.

The plurality of crests 11 and recesses 12 on the surface 5 of the coronal portion 3 of the inlay 2 are arranged symmetrically and suitable for the pressing or for the injection of an outer abutment part 1′.

When an outer abutment part 1′ is pressed or provided by injection onto the surface 5, part of the abutment base material is grated off a first 13 and a second lateral face 14 which form a kind of wedge at a respective recess 12, and provides for a positive engagement with the outer surface 5 of the coronal portion 3 of the inlay 2.

The positive engagement generated in this manner creates a nearly monolithic unit; thus, a rotation of the outer abutment part 1′ about its own axis is no longer possible. On the side facing the outer abutment part 1′, an upper edge 15 of the coronal portion 3 is beveled at an angle of approximately 45 degrees so that the outer abutment portion 1′ to be pressed on or provided by injection can be easily positioned or manufactured, respectively. On the lower side of the coronal portion 3, another, lower edge 16 is arranged which is also beveled, however with a smaller angle.

According to an advantageous aspect of the invention, the plurality of crests 11 and recesses 12 increases the overall surface of the coronal portion 3, resulting in better adhesion of the abutment material to the surface 5 of the coronal portion 3. In this way, the outer abutment part 1′ can be non-detachably and positively fitted on the inlay 2 by an injection-molding method.

Other embodiments of the profiles on the surface 5 of the coronal portion 3 are possible as well, e. g. the profile may only be formed partly on the surface. The surfaces may be provided with grooves, a cross-like structure or randomly applied structures, at least one having an axial direction for providing an anti-rotational securing.

FIG. 3 shows another embodiment of an abutment having an inlay according to the present invention. The embodiment in FIG. 3 is similar to the one in FIGS. 1 to 2D so that basically the same reference numbers can be used as in FIG. 1 or FIGS. 2A through 2D, respectively.

Deviating from this, the conical portion 10, decreasing in diameter, extends from the second edge 8 in the direction of the apical portion 4 used for insertion in a complementary cone portion of the dental implant not shown, with a slight curvature.

Moreover, the cross-section of the conical shoulder portion 9 is larger in this embodiment than the one of the embodiment in FIG. 1. The apical portion 112 of the outer abutment part 1′ is pear-shaped and has a shoulder 113 which then transitions to a cylindrical portion 114 which substantially corresponds to the outer diameter of the inlay 2.

### LIST OF REFERENCE NUMBERS

1=abutment

1′=outer abutment part

2=inlay

3=coronal portion

4=apical portion

5=surface of coronal portion

6=rotationally symmetrical cylindrical portion

7=first edge

8=second edge

9=conical shoulder portion

10=conical portion

11=crests

12=recesses

13=first lateral face

14=second lateral face

15=upper edge of coronal portion

16=lower edge of coronal portion

112=apical portion of the abutment

113=shoulder of the abutment

114=cylindrical portion of the abutment

1-10. (canceled)

11. An abutment with inlay for dental implants comprising an outer abutment part and an inlay arranged apically within the outer abutment part, the inlay having a coronal portion suitable for providing a connection between the inlay and the outer abutment part and an apical portion suitable for releasable attachment to a dental implant, wherein the surface of the coronal portion of the inlay is formed such as to attach with a positive engagement the outer abutment part that is to be affixed thereto in a non-detachable manner.

12. The abutment with inlay according to claim 11, wherein at least part of the surface of the coronal portion of the inlay has a profile to which the outer abutment part can be attached.

13. Abutment with inlay according to claim 12, wherein a rotationally symmetrical cylindrical portion directly borders on the coronal portion, the rotationally symmetrical cylindrical portion having a smaller diameter as compared to the profile, thus forming an undercut.

14. The abutment with inlay according to claim 12, wherein the profile is substantially formed on the entire surface of the coronal portion of the inlay.

15. The abutment with inlay according to claim 12, wherein the profile on the surface of the coronal portion consists of a plurality of crests and recesses.

16. The abutment with inlay according to claim 14, wherein the profile on the surface of the coronal portion consists of a plurality of crests and recesses.

17. The abutment with inlay according to claim 16, wherein the plurality of crests and recesses are arranged symmetrically on the surface of the coronal portion.

18. The abutment with inlay according to claim 16, wherein the plurality of crests and recesses form a cross-like structure.

19. The abutment with inlay according to claim 17, wherein the plurality of crests and recesses form a cross-like structure.

20. The abutment with inlay according to claim 11, wherein the outer abutment portion is positively engaged with and non-detachably attached to the inlay by an injection-molding process.

21. The abutment with inlay according to claim 11, wherein the surface of the coronal portion of the inlay is produced by means of a cutting method, such as milling, or a non-cutting method, such as stamping.

22. The abutment with inlay according to claim 11, wherein the outer abutment part is attached to the coronal portion of the inlay by positive engagement.
